(19) United States
(12) Patent Application Publication
(10) Pub. No.: US 2018/0200721 A1
(43) Pub. Date: Jul. 19, 2018

(54) ROTOR FOR AN IMPACT CRUSHER

(71) Applicants: THYSSENKRUPP INDUSTRIAL SOLUTIONS AG, Essen (DE); thyssenkrupp AG, Essen (DE)

(72) Inventors: Piotr SZCZELINA, Beckum (DE); Thomas GERNHARDT, Witten (DE); Ute DUWENDAG, Lengerich (DE); Daniel STEINSTRÄTER, Beckum (DE)

(73) Assignees: THYSSENKRUPP INDUSTRIAL SOLUTIONS AG, Essen (DE); thyssenkrupp AG, Essen (DE)

(21) Appl. No.: 15/743,378

(22) PCT Filed: Jun. 21, 2016
(86) PCT No.: PCT/EP2016/064283

§ 371 Date: Jan. 10, 2018

(30) Foreign Application Priority Data
Jul. 23, 2015 (DE) 10 2015 213 958.1

(51) Int. Cl. B02C 13/28

(52) U.S. Cl. CPC B02C 13/2804; B02C 2013/29

(57) ABSTRACT

A rotor of an impact crusher may include a crushing roll body and at least one holding device that is mounted on the crushing roll body and is configured to hold a blow bar. The holding device may have a guide frame and at least one guide element. The guide element may be connected to the blow bar and may be movably mounted on the guide frame such that movement of the guide element relative to the guide frame in a radial direction results in movement of the blow bar relative to the crushing roll body in the radial direction. The guide element can be arranged so as to be movable in an axial direction relative to the blow bar.

The invention relates to a rotor of an impact crusher.

Impact crushers are generally used to break down materials such as limestone, marl, clay, rubble or similar mineral materials. Known impact crushers have a rotor with blow bars spaced uniformly apart. The rotor interacts with a second rotor rotating in the opposite direction or with impact elements arranged to the side of the rotor, for example, in order to break down the material.

In the case of known impact crushers, the blow bars are each wedged, e.g. hydraulically, in a recess in the crushing roll body. The blow bars of such an impact crusher are subject to severe wear and require regular maintenance. In the case of wear, the blow bar of known impact crushers is either completely replaced or turned around, with the result that the opposite end of the blow bar is subject to wear. An impact crusher of this kind is known from DE3521588 A1, for example.

Replacing the blow bars is very time-consuming and requires long downtimes of the impact crusher. Moreover, the quality of the product deteriorates with increasing wear of the blow bars.

On this basis, it is the object of the present invention to provide a rotor for an impact crusher which overcomes the abovementioned disadvantages and offers a way of adapting the position of the blow bars to the state of wear of the blow bars or to the nature of the materials.

According to the invention, this object is achieved by a rotor for an impact crusher having the features of independent device claim 1. Advantageous developments will become apparent from the dependent claims.

According to a first aspect, a rotor comprises a crushing roll body and at least one holding device, mounted on the crushing roll body, for holding a blow bar, wherein the holding device has a guide frame and at least one guide element, which is connected to the blow bar and is movably mounted on the guide frame in such a way that movement of the guide element in the radial direction relative to the guide frame results in movement of the blow bar in the radial direction relative to the crushing roll body, wherein the guide element is arranged so as to be movable in the axial direction relative to the blow bar.

The terms “radial direction”, “radially”, “axial direction” and “axially” should be understood with reference to the crushing roll body.

The crushing roll body is of substantially cylindrical design and, during the operation of the impact crusher, rotates about its center line. The impact crusher preferably has a plurality of blow bars, which are mounted on the circumference of the crushing roll body at a uniform spacing with respect to one another. For example, each of the blow bars is mounted in a respective holding device. On the one hand, the crushing roll body of the impact crusher has the function of holding the blow bars and, on the other hand, that of transmitting the torque from the rotor shaft passing through the crushing roll body to the blow bars in order to apply the required crushing force. The blow bars are each arranged in a recess in the crushing roll body, wherein they project by a predetermined height above the outer circumference of the crushing roll body. The guide frame is preferably of substantially box-shaped design and serves to guide the at least one guide element along a predetermined plane.

The blow bar is preferably mounted on the guide frame via the guide element, allowing the blow bar to be moved in the radial direction relative to the crushing roll body by means of the guide element. Radial movement of the guide element brings about radial movement of the blow bar, wherein axial movement of the guide element is decoupled from the blow bar. The guide element can be moved in the axial direction relative to the blow bar and does not cause any movement of the blow bar in the axial direction.

Movement of the blow bar in the radial direction allows adaptation of the position of the blow bar in accordance with the wear of the blow bar, ensuring that the blow bar projects above the outer circumference of the crushing roll body by the predetermined height. In particular, movement of the guide element relative to the guide frame results in continuous, stepless movement of the blow bar in the radial direction relative to the crushing roll body. The ability for continuous movement of the blow bar in the radial direction allows precise radial positioning of the blow bars in accordance with the state of wear or the nature of the material to be broken down, for example. This ensures constant product quality, which does not deteriorate with increasing wear of the blow bars. Moreover, the downtimes of the impact crusher are reduced since replacement of the blow bars is necessary only when the blow bar is almost completely worn.

According to another embodiment, the crushing roll body has a recess, in which the holding device is accommodated and detachably connected to the crushing roll body. In particular, the holding device is accommodated fully in the recess of the crushing roll, with the result that the holding device does not project from the crushing roll body. This enables the blow bar to be accommodated in an optimum manner in the holding device, wherein wear of the holding device is avoided.

According to another embodiment, the guide element is of substantially wedge-shaped design. In particular, the radially outward-facing side face of the guide element has a slope angle of about 5-30°, in particular 10.5°, to the axial direction. Moreover, the side face facing in the direction of the guide frame, in particular, has a slope angle of about 10 to 30°, in particular 14°.

According to another embodiment, the holding device has a first threaded spindle, by means of which the guide element is mounted on the guide frame. In particular, the guide element has a threaded hole, which passes in the axial direction through the guide element and through which the threaded spindle extends. Movement of the guide element within the guide frame is thereby made possible in a simple manner. The threaded spindle preferably extends in the axial direction through the guide frame.

According to another embodiment, the holding device has a clamping element, which is mounted movably in the guide frame in such a way that movement of the clamping element in the radial direction results in movement of the guide element in the radial direction. In particular, the clamping element is arranged below, radially on the inside relative to the guide element and is arranged so as to be movable in such a way that it moves the guide element in the radial direction. In particular, the clamping element is arranged so as to be movable in the axial direction relative to the guide element, with the result that axial movement of the clamping element does not cause any axial movement of the guide element.

According to another embodiment, the clamping element is mounted movably in the guide frame in such a way that it can be moved into a blocking position, in which it prevents movement of the guide element in the radial direction. In the blocking position, the clamping element rests against the guide element, in particular by means of its radially outward-facing surface, wherein the guide element rests against the guide frame in such a way that movement in the radial direction is prevented. This enables the guide element to be fixed in the radial direction, in particular inward in the radial direction, wherein at the same time fixing of the blow bar in the radial direction is achieved, ensuring that a predetermined height to which the blow bar projects beyond the crushing roll body is maintained.

According to another embodiment, the clamping element can be moved parallel to the direction of movement of the guide element.

According to another embodiment, the clamping element is mounted on the guide frame by means of a second threaded spindle. In particular, the second threaded spindle extends parallel to the first threaded spindle and allows movement of the clamping element.

According to another embodiment, the clamping element is of substantially wedge-shaped design. In particular, the radially inward-facing surface of the clamping element is aligned at an angle of about 5-30°, in particular 10.5°, to the axial direction.

According to another embodiment, the guide element has a projection, in particular a trapezoidal projection. The projection preferably extends along the entire length of the guide element in the axial direction.

According to another embodiment, the blow bar has a groove, in particular a trapezoidal groove, which extends in the axial direction and is in engagement with the projection of the guide element. This allows positive connection of the guide element to the blow bar, with the result that the blow bar moves with the guide element. Moreover, a groove extending in the axial direction allows movement of the guide element in the axial direction relative to the blow bar within the groove. The projection and the groove have a rectangular or round shape, for example.

According to another embodiment, at least one of the first and the second threaded spindle has a first region with a right-hand thread and a second region with a left-hand thread. A respective guide element or clamping element is preferably arranged on each of the first and second regions, wherein the guide elements and clamping elements move in opposite directions when the threaded spindle is rotated.

According to another embodiment, a spring element is arranged between the first region and the second region. A spring element prevents the loss of the preloading of the threaded spindle during rotation, wherein the guide elements arranged on the threaded spindle move in opposite directions. By way of example, the spring element has a sleeve, within which a spring, e.g. a helical compression spring or a plurality of diaphragm springs, is arranged. In particular, the sleeve is connected for conjoint rotation to the first and second regions of the threaded spindle, with the result that relative rotation between the sleeve and the threaded spindle is prevented and, at the same time, movement of the first region relative to the second region in the axial direction is made possible. Such an arrangement furthermore allows preloading of the first region relative to the second region of the threaded spindle.

According to another embodiment, the first and the second threaded spindle are mounted in the guide frame in such a way that they can be moved in the radial direction. In particular, the guide frame has a slotted hole, which extends in the radial direction and in which the first and second threaded spindles are arranged. Movement of the threaded spindles in the radial direction allows movement of the guide element along the threaded spindle in the axial direction with a simultaneous movement in the radial direction.

According to another embodiment, two guide elements are mounted on the first threaded spindle, wherein two clamping elements are mounted on the second threaded spindle. The two guide elements are each connected to the blow bar in a positive manner in the radial direction and allow uniform guidance of the blow bar in the radial direction. The clamping elements are used to fix and move a respective guide element inward in the radial direction.

According to another embodiment, the guide frame has a guide surface for guiding a respective guide element. In particular, the guide surface for guiding a guide element is arranged at an angle of about 5-30°, in particular 14°, to the radial direction. The guide surface is preferably formed in such a way that it interacts with the side face of the guide element which faces in the direction of the holding device, and guides the guide element along a plane which, in particular, extends at an angle of about 5-30°, in particular 10.5°, to the axial direction. An additional slope of the guide surface at an angle to the radial direction enables the blow bar to be subjected to a force substantially in the circumferential direction, with the result that the blow bar is pressed against the recess in the crushing roll body by the guide element.

According to another embodiment, the guide frame has a guide surface for guiding a respective clamping element. In particular, the guide surface for guiding the clamping element has an angle of about 5-30°, in particular 10.5°, to the axial direction. The guide surface is preferably designed in such a way that it interacts with the radially inward-facing surface of the clamping element, thus allowing optimum guidance of the clamping element.

### DESCRIPTION OF THE DRAWINGS

The invention is explained in greater detail below by means of a number of illustrative embodiments with reference to the attached figures.

FIG. 1 shows a perspective view of a rotor of an impact crusher having a plurality of blow bars according to one illustrative embodiment.

FIG. 2 shows a perspective view of a holding device having a blow bar according to one illustrative embodiment.

FIG. 3 shows a perspective view of a guide frame according to the illustrative embodiment from FIG. 2.

FIG. 4 shows a guide element in a perspective view and a front view according to the illustrative embodiment from FIG. 2.

FIG. 5 shows a perspective view of a clamping element according to the illustrative embodiment from FIG. 2.

FIG. 6 shows a perspective view of a blow bar according to the illustrative embodiment from FIGS. 1 and 2.

FIG. 7 shows a perspective view of a driving device according to another illustrative embodiment.

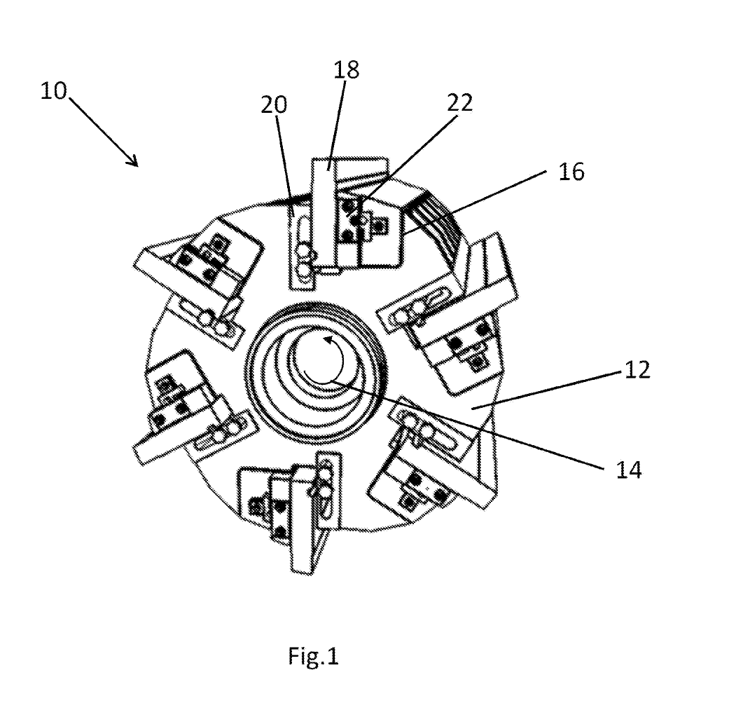

FIG. 1 shows a rotor 10 of an impact crusher for breaking down limestone, marl, clay, rubble or similar mineral materials. The rotor 10 comprises a substantially cylindrical crushing roll body 12 having a central axial hole 14 to receive a shaft (not shown) for driving the crushing roll body. During the operation of the impact crusher, the rotor 10 rotates in the direction of the arrow, wherein the blow bars 18 interact, for example, with another rotor (not shown in FIG. 1) rotating in the opposite direction or with impact elements (not shown) arranged to the side of the rotor 10.

On its outer circumference, the crushing roll body 12 has six recesses 16, which extend in the axial direction and in each of which a blow bar 18 and a holding device 20 are arranged. The substantially plate-shaped blow bars 18 extend in the axial direction over the entire length of the crushing roll body 12, with the result that they each end at the side faces of the crushing roll body 12. In the radial direction, the blow bars 18 each extend over about a third of their height beyond the outer circumference of the crushing roll bodies 12 and extend with about two thirds of their height into the crushing roll bodies 12. The blow bars 18 are spaced apart uniformly over the circumference of the crushing roll bodies 12. Each blow bar 18 rests against the holding device 20 by means of the side face facing in the direction of rotation and against the crushing roll body 12 by means of the opposite side face. Furthermore, fastening means 22, which prevent movement of the blow bars 18 in the axial direction, are mounted on the crushing roll body 12. The fastening means 22 are preferably plates mounted on the side face of the crushing roll bodies 12, which are, for example, screwed to the crushing roll body and interact with the blow bar, ensuring that the blow bar 18 is fixed in the axial direction. The holding device 20 extends in the radial direction along the side face of the respective blow bar 18 which extends within the crushing roll body 12, and the holding device ends flush with the circumference of the crushing roll bodies 12. In the axial direction, the holding device 20 extends axially in the recess 16 over the entire length of the crushing roll body 12. The holding device 20 is mounted detachably on, e.g. screwed to, the crushing roll body 12, thus enabling the holding device to be replaced when required.

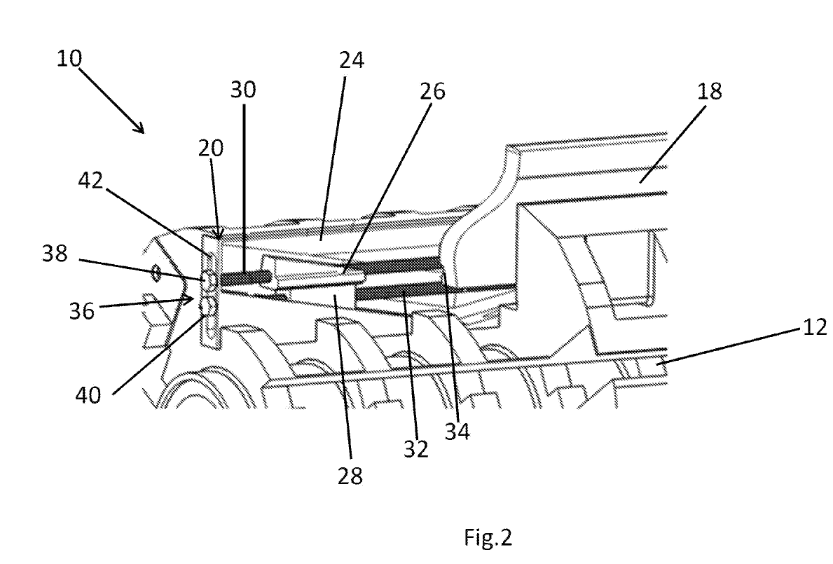

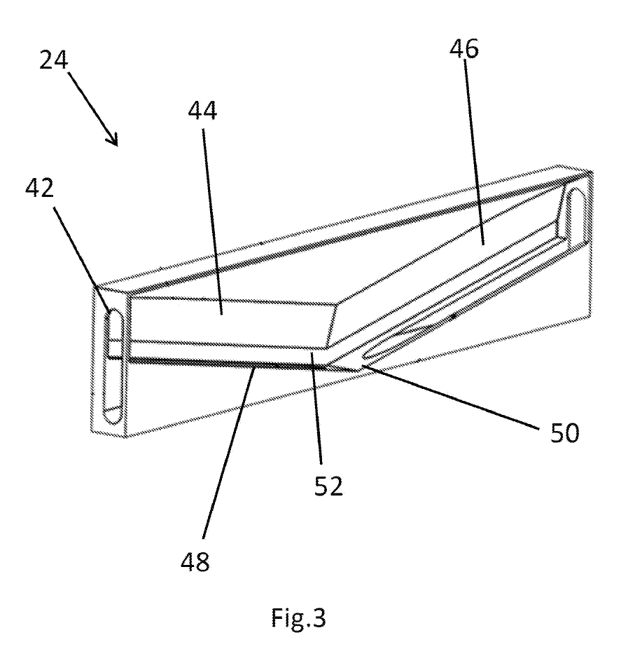

FIG. 2 shows a detailed illustration of the holding device 20 from FIG. 1, wherein the blow bar 18 is shown partially in section for the sake of simplicity. The holding device 20 has a guide frame 24, which is of substantially box-shaped design and has a plurality of guide surfaces. The design of the guide frame 24 is described in detail with reference to FIG. 3. Two guide elements 26 and two clamping elements 28 are furthermore arranged in the guide frame 24, wherein only one guide element 26 and one clamping element 28 are shown in FIG. 2, each being movable along the guide surfaces 44, 46, 48, 50 illustrated in FIG. 3. The holding device furthermore comprises a driving device 36, which has a first threaded spindle 30 and a second threaded spindle 32. The threaded spindles 30, 32 extend parallel to one another through the guide frame 24 in the longitudinal direction of the guide frame 24. Two guide elements 26 are arranged on the first threaded spindle 30, which is arranged above the second threaded spindle 32, in particular radially to the outside of the second threaded spindle 32, wherein two clamping elements 28 are arranged on the second threaded spindle 32. The threaded spindles 30, 32 are each mounted by means of fastening elements 38, 40, in particular nuts, in a slotted hole 42 extending through the guide frame 24, thus preventing axial movement of the threaded spindles 30, 32 and allowing radial movement of the threaded spindles 30, 32. The threaded spindles 30, 32 each have threads, in particular two threads, a right-hand thread and a left-hand thread, wherein these each extend as far as the center of the threaded spindle, with the result that one of the ends of the threaded spindles 30, 32 has a right-hand thread and the other end of the threaded spindles 30, 32 has a left-hand thread. The guide elements 26 are arranged at respective opposite ends of threaded spindle 30 and are at the same distance from the respective end of the threaded spindle, with the result that, when threaded spindle 30 is rotated, the guide elements 26 move in opposite directions on threaded spindle 30. The clamping elements 28 are mounted on the second threaded spindle 32 in the same way, with the result that they likewise move in opposite directions.

The guide frame 24 illustrated in FIG. 3 has a rear wall 52, which rests against the crushing roll body 12 in the state of the guide frame 24 in which it is installed in the crushing roll body 12. Four guide surfaces 44, 46, 48, 50 are formed in the guide frame 24, and the guide elements 26 and the clamping elements 28 are guided along said surfaces. Guide surfaces 48 and 50 each serve to guide a clamping element 26 and are arranged in a V shape relative to one another and at right angles to the rear wall 52. Guide surfaces 48 and 50 are of flat design and each extend from the center of the longitudinal side of the guide frame 24 at a slope angle of about 5-30°, in particular 10-20°, preferably 10.5°, to the axial direction of the rotor 10 toward the side faces of the guide frame 24. Guide surfaces 44 and 46 each serve to guide a guide element 26 and are arranged substantially in a V shape relative to one another, wherein guide surfaces 44 and 46 are arranged at an angle of about 10-30°, in particular 12-20°, preferably 14°, to the rear wall 52 of the guide frame. The slope angle of guide surfaces 44 and 46 relative to the axial direction is about 5-30°, in particular 10-20°, preferably 10.5°, and corresponds to the slope of guide surfaces 48 and 50, wherein guide surfaces 44 and 46 for guiding a respective guide element 26 are arranged above guide surfaces 48 and 50, in particular radially to the outside thereof.

The guide frame 24 furthermore has a slotted hole 42 elongated in the radial direction, which extends in the longitudinal direction of the guide frame 24, in particular in the axial direction of the crushing roll body 12, through the guide frame 24 and through which the first and second threaded spindles 30, 32 illustrated in FIG. 2 extend. The slotted hole 42 furthermore extends through guide surfaces 48 and 50.

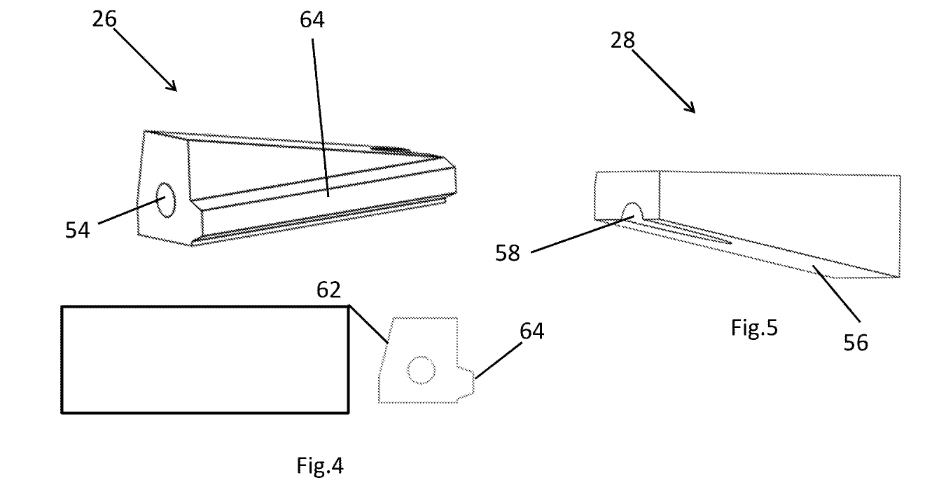

A guide element 26 illustrated in FIG. 4 has a substantially wedge-shaped form, wherein the upward-, radially outward-facing surface forms an angle of about 5-30°, in particular 10-20°, preferably 10.5° to the longitudinal axis of the guide element 26, in particular to the axial direction of the rotor 10. The side of the guide element 26 which faces in the direction of the holding device 20 has a side face which extends substantially in the radial direction and a contact surface 62 which rests against guide surface 44 of FIG. 3 and is designed to match the angular orientation of guide surface 44. The contact surface 26 forms an angle of about 10-30°, in particular 12-20°, preferably 14°, to the side face and to the radial direction of the rotor 20. The surface of the guide element 26 which faces the blow bar 18 has a trapezoidal projection 64, which extends along the lower, radially inward edge of the guide element 26. The trapezoidal projection 64 serves to connect the guide element 26 positively to the blow bar 18. A threaded hole 54 for accommodating the first threaded spindle 30 extends in the longitudinal direction through the guide element 26. A guide element 26 resting against guide surface 46 has a symmetrical construction with respect to the guide element 26 illustrated in FIG. 4.

The clamping element 28 illustrated in FIG. 5 is of substantially wedge-shaped design, wherein the downward-, radially inward-facing surface forms a contact surface 56, which rests against guide surface 48 of the guide frame 24 and is designed to match the angular orientation of guide surface 48. The contact surface 56 is substantially flat and has an angle of about 5-30°, in particular 10-20°, preferably 10.5°, to the axial direction. A threaded hole 58 for accommodating the second threaded spindle 32 extends in the longitudinal direction through the clamping element 28. When installed in the guide frame 24, the upper, radially outward-facing surface of the clamping element 28 rests against the lower, radially inward-facing surface of the guide element 26. A clamping element resting against guide surface 50 has a symmetrical construction with respect to the clamping element 28 illustrated in FIG. 4.

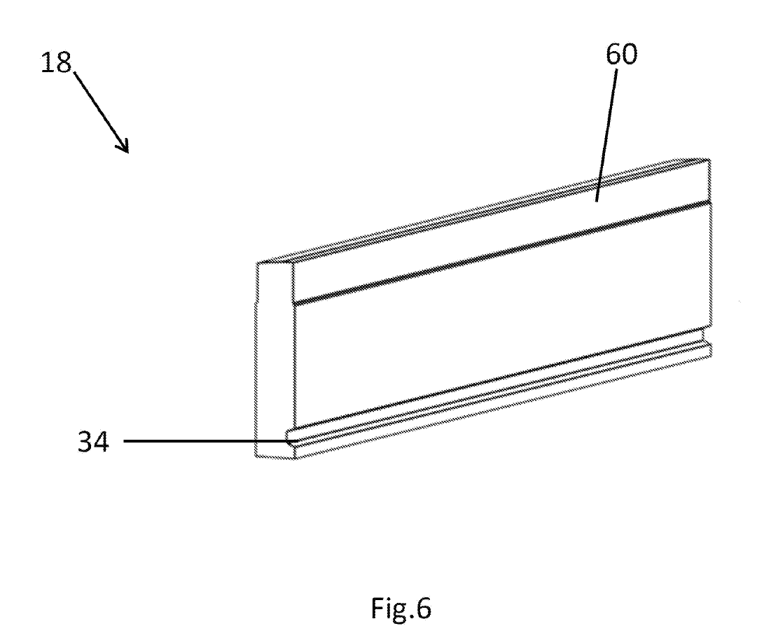

FIG. 6 shows a blow bar 18 which has a trapezoidal groove 34 in the side face which faces the holding device in the installed state. The groove 34 extends in the longitudinal direction of the blow bar 18 along the lower, radially inward-facing edge and is used to connect the blow bar 18 to the guide elements 26. In the installed state illustrated in FIG. 2, the trapezoidal groove 34 of the blow bar 18 interacts with the trapezoidal projection 34 of the guide elements 26, thus allowing the guide elements 26 to be moved relative to the blow bar 18 along the groove 34. The blow bar 18 furthermore has an impact surface 60, which is arranged on the radially outward end region of the side face and, for example, has a wear-resistant coating (not shown here).

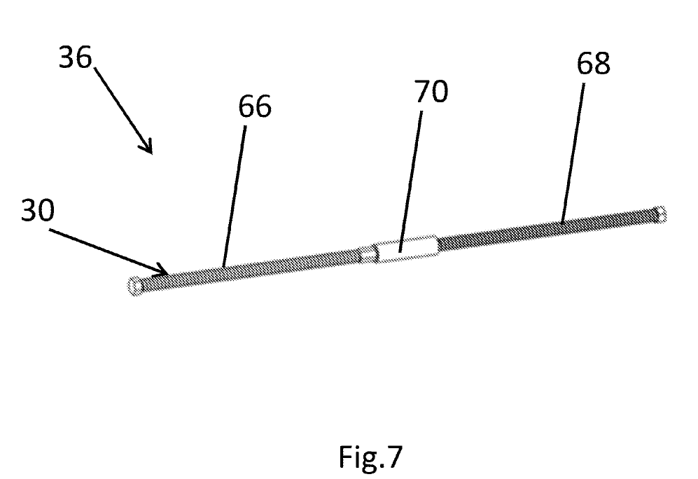

FIG. 7 shows a segment of a driving device 36, wherein only one threaded spindle 30 is illustrated by way of example. The threaded spindle 30 has a first section 66 and a second section 68, which have different threads. For example, the first section 66 has a right-hand thread and the second section 68 has a left-hand thread. Arranged between the first section 66 and the second section 68 is a spring element 70, which has a sleeve, in which a spring, e.g. a helical compression spring or a plurality of diaphragm springs, is arranged. The sleeve is connected to the first section 66 and the second section 68 of the threaded spindle in such a way that axial movement of the sections 66, 68 is possible but twisting of the sections 66, 68 relative to one another is prevented. The ends of the sections 66, 68 which face toward the center of the threaded spindle 30 preferably have an external hexagon, which interacts with an internal hexagon formed in the sleeve and thus prevents twisting of the sections 66, 68 relative to one another and allows movement of the sections relative to one another in the axial direction. The spring element ensures preloading between the sections 66 and 68, for example, and thus prevents incorrect tightening of the threaded spindle.

To move the blow bar in the radial direction, the first threaded spindle 30 is rotated, with the result that the guide elements 26 move outward along threaded spindle 30 in the axial direction. The different threads of the threaded spindle ensure that the guide elements 26 move in opposite directions to one another. The connection between the blow bar 18 and the guide elements 26 by means of a positive connection, which comprises a trapezoidal projection on the guide elements 26 in the trapezoidal groove 34 of the blow bar, enables the guide elements 26 to slide along the groove 34 in the axial direction, with the result that the blow bar 18 moves in the radial direction with the guide elements 26 but not in the axial direction. For radial movement of the blow bar 18, the second threaded spindle 32 is rotated, with the result that the clamping elements 28 each slide under a guide element 26 and move the latter against the guide surfaces 44, 46, 48, 50. The clamping elements in each case move the guide elements in the radial direction into a blocking position, in which the guide elements rest against the guide surfaces 44, 46 and an outward movement in the radial direction is prevented. In the blocking position, the clamping elements are each arranged radially on the inside relative to a guide element, with the result that an inward movement of the guide element 26 in the radial direction is prevented. The threaded spindles 30, 32 are driven manually, for example, or by means of an external driving device, such as a hydraulic motor or an electric motor.

The arrangement described provides simple and reliable adjustment of the blow bars in the radial direction, and therefore replacement of the overall blow bar 18 is necessary only when there is very severe wear, and the height of the blow bar 18 can be adapted at any time to the properties of the respective materials to be broken down. In particular, the arrangement allows continuous, stepless movement of the blow bar in the radial direction, as a result of which precise positioning of the blow bar is possible. This allows a considerable time-saving in the case of wear of the blow bars and prevents long downtimes of the impact crusher.

### LIST OF REFERENCE NUMERALS

10 Rotor
12 Crushing roll body
14 Hole
16 Recess
18 Blow bar
20 Holding device
22 Fastening means
24 Guide frame
26 Guide element
28 Clamping element
30 First threaded spindle
32 Second threaded spindle
34 Trapezoidal groove
36 Driving device
38 Fastening means
40 Fastening means
42 Recess
44 Guide surface
46 Guide surface
48 Guide surface
50 Guide surface
52 Rear wall
54 Threaded hole
56 Guide surface
58 Threaded hole
60 Impact surface
62 Contact surface
64 Trapezoidal projection
66 First section of the threaded spindle
68 First section of the threaded spindle
70 Spring element

1.-17. (canceled)

18. A rotor of an impact crusher comprising:
a crushing roll body; and
a holding device that is mounted on the crushing roll body, wherein the holding device is for holding a blow bar and comprises
a guide frame, and
a guide element that is connected to the blow bar and is movably mounted on the guide frame such that movement of the guide element relative to the guide frame in a radial direction results in movement of the blow bar relative to the crushing roll body in the radial direction, wherein the guide element is movable in an axial direction relative to the blow bar.

19. The rotor of claim 18 wherein the crushing roll body has a recess in which the holding device is received and detachably connected to the crushing roll body.

20. The rotor of claim 18 wherein the guide element is substantially wedge-shaped.

21. The rotor of claim 18 wherein the holding device includes a first threaded spindle by way of which the guide element is mounted on the guide frame.

22. The rotor of claim 18 wherein the holding device has a clamping element that is mounted movably in the guide frame such that movement of the clamping element in the radial direction results in movement of the guide element in the radial direction.

23. The rotor of claim 22 wherein the clamping element is mounted movably in the guide frame such that the clamping element is movable into a blocking position in which the clamping element prevents movement of the guide element in the radial direction.

24. The rotor of claim 23 wherein the clamping element is movable parallel to a direction of movement of the guide element.

25. The rotor of claim 23 wherein the clamping element is substantially wedge-shaped.

26. The rotor of claim 23 wherein the holding device includes a first threaded spindle by way of which the guide element is mounted on the guide frame, wherein the clamping element is mounted on the guide frame by way of a second threaded spindle.

27. The rotor of claim 26 wherein the first threaded spindle and the second threaded spindle are mounted in the guide frame such that the first and second threaded spindles are movable in the radial direction.

28. The rotor of claim 26 wherein the guide element is a first guide element and the clamping element is a first clamping element, wherein the first guide element and a second guide element are mounted on the first threaded spindle, wherein the first clamping element and a second clamping element are mounted on the second threaded spindle.

29. The rotor of claim 26 wherein at least one of the first threaded spindle or the second threaded spindle includes a first region with a right-hand thread and a second region with a left-hand thread.

30. The rotor of claim 29 further comprising a spring element disposed between the first region and the second region.

31. The rotor of claim 18 wherein the guide element includes a projection.

32. The rotor of claim 31 wherein the blow bar includes a groove that extends in the axial direction and engages with the projection of the guide element.

33. The rotor of claim 18 wherein the guide frame includes a guide surface for guiding a guide element.

34. The rotor of claim 18 wherein the guide frame includes a guide surface for guiding a clamping element.

35. The rotor of claim 18 wherein the guide element includes a trapezoidal projection, wherein the blow bar includes a trapezoidal groove that extends in the axial direction and engages with the trapezoidal projection of the guide element.
